(19) United States
(12) Patent Application Publication
(10) Pub. No.: US 2005/0132420 A1
(43) Pub. Date: Jun. 16, 2005

(54) System and method for interaction with television content

(75) Inventors: Daniel H. Howard, Atlanta, GA (US); James B. Langford JR., Atlanta, GA (US); Alix T. Howard, Atlanta, GA (US); Paul D. Haynie, Atlanta, GA (US); James R. Harrell, Atlanta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: QUADROCK COMMUNICATIONS, INC, Atlanta, GA (US)

(21) Appl. No.: 11/009,927

(22) Filed: Dec. 10, 2004

Related U.S. Application Data
(60) Provisional application No. 60/528,676, filed on Dec. 11, 2003.

(51) Int. Cl. H04N 7/16; G10L 21/00; G10L 11/00; G10L 15/04; G10L 17/00; G10L 15/00; G06F 13/00; H04N 5/445; G06F 3/00; G06F 17/27

(52) U.S. Cl. 725/135; 725/38; 725/139; 704/246; 704/251; 704/275; 704/9

(57) ABSTRACT

A system and method for interaction with television programming uses either existing analog television programming with interactive content transmitted via separate communications channel or digital television with embedded interactive content in conjunction with a powerful viewer interface to provide a fully interactive television experience that is dynamic and personalized to each viewer.

### CROSS-REFERENCE TO RELATED APPLICATIONS

This application claims the benefit under 35 U.S.C. §119(e) of U.S. Provisional Patent Application Ser. No. 60/528,676 for “System and Method for Interaction with Television Content,” which was filed Dec. 11, 2003, and which is incorporated herein by reference in its entirety.

### BACKGROUND OF THE INVENTION

1. Field of the Invention

The present invention relates to television systems, and more particularly, to systems and methods for viewer interaction with television programming, advertisements, and other interactive content.

2. Related Art

Interactive television (TV) has already been deployed in various forms. The electronic program guide (EPG) is one example, where the TV viewer is able to use the remote control to control the display of programming information such as TV show start times and duration, as well as brief synopses of TV shows. The viewer can navigate around the EPG, sorting the listings, or selecting a specific show or genre of shows to watch or tune to at a later time. Another example is the WebTV interactive system produced by Microsoft, wherein web links, information about the show or story, shopping links, and so on are transmitted to the customer premises equipment (CPE) through the vertical blanking interval (VBI) of the TV signal. Other examples of interactive TV include television delivered via the Internet Protocol (IP) to a personal computer (PC), where true interactivity can be provided, but typically only a subset of full interactivity is implemented. For the purposes of this patent application, full interactivity is defined as fully customizable screens and options that are integrated with the original television display, with interactive content being updated on the fly based on viewer preferences, demographics, other similar viewer's interactions, and the programming content being viewed. The user interface for such a fully interactive system should also be completely flexible and customizable, and should permit a variety of user data entry methods such as conventional remote controls, optical recognition of hand gestures, eye movements and other body movements, speech recognition, or in the case of disabled viewers, a wide range of assisted user interface technologies along with any other user data interface and input devices and methods.

No current interactive TV system intended for display on present-day analog televisions provides this type of fully interactive and customizable interface and interactive content. The viewer is presented with either a PC screen that is displayed using the TV as a monitor, or the interactive content on an analog television is identical for all viewers. It is therefore desirable to have a fully interactive system for current and future television broadcasting where viewers can interact with the programming in a natural manner and the interactive content is customized to the viewer's preferences and past history of interests, as well as to the interests of other, similar viewers.

A key problem limiting the ability to of viewers to fully interact with television programming and information displayed on the television is the lack of a completely flexible display and a powerful data input system that allows users to communicate desired actions naturally and without significant training. A system that provides this fully interactive interface between television and viewer is described in this patent.

### BRIEF SUMMARY OF THE INVENTION

The present invention is directed to a method and system for interacting with television content using a powerful display and viewer command and data entry system. The system is capable of complete customization of the television display, and viewers can input commands to the system via conventional remote control button-pushing, mouse and pen based selections, speech or other sounds from the human voice, hand and other body gestures, eye movements, and body actions such as standing, sitting, leaving, entering (as in the room) or even laughing.

In one aspect of the present invention there is provided a system for capturing and processing the speech and other sounds of the human voice in order to effect commands on the interactive television system. In addition to conventional human speech commands such as “go to CNN,” “shop” or “more info”, the speech can be used to aid in image pattern recognition. For example, if a coffee cup is in the television image, the viewer can pause the video, say the words “coffee cup” and the speech recognition system recognizes the words “coffee cup” and then the image recognition system scans the image looking for the best match to a coffee cup. Once the correct image is acquired, the viewer may make a purchase, or obtain more information. Thus, the speech recognition system is used both for input of commands as well as to aid other recognition processing in the system. The speech recognition system can reside in a remote server, a device for integrating interactive content with television programming in the customer premises, in an advanced remote control held by the viewer, or the functionality can be distributed among some or all of these devices.

In another aspect there is provided a method whereby the television program is paused for immediate interaction and the interactive system then transitions to an interactive portal display that includes the image of the paused television programming, but also includes interactive buttons or links and further includes outlines of objects in the frozen image on the television which can be selected for interactive activities such as shopping, learning, or chatting. Alternately, the viewer may simply “bookmark” a frame while continuing to pursue the content stream. Then at a later time the viewer can go back and view their various bookmarks for items of interest and follow up on those items without interrupting the flow of the particular show they were watching. The object outlines can be sent to the customer premises equipment from a remote server, or can be determined locally in an interactive television integrator by a combination of MPEG4 and other video compression technologies, image pattern recognition, and other pattern recognition technologies. Viewers can also outline the objects manually by using an advanced remote control that displays the frozen television image and allows users to outline an object of interest for subsequent pattern recognition and interactive activity. A typical activity would include the viewer selecting an object in the frozen television image and purchasing a version of that object. Methods by which the television program is paused include, but are not limited to, manually pausing the television program via viewer command, or automatically pausing the system upon detection of events such as viewers leaving the room.

In another aspect, there is provided a method where viewers can interact with the television programming via hand gestures and body movements. An infrared (IR) or video camera in the customer premises captures images from the viewer and an image recognition system detects positions and movements of body parts. For the IR-based system, the viewer's motions are detected and recognized. In this manner, the viewer can point to something on the screen and the interactive system can highlight that portion of the screen for further commands. Also, when a viewer stands up, or leaves the room, the system detects this and can alter the presentation of interactive content appropriately by pausing the program, for example, or by increasing the volume, or by sending the video to an alternate display device such as an advanced remote control. The camera is also used for viewer identification. This body movement detection system is also useful for interactive applications such as exercise television programs, video gaming applications, and other interactive applications where the viewer physically interacts with the television programming.

In another aspect, there is provided a system for detecting RF or other electronic tags or bar codes on products and/or viewers so that the interactive system is able to identify viewers or to identify products they have in their possession in order for the system to automatically inform viewers of updates or promotions or to track supplies of products in the viewer's premises for automatically ordering replacements. In addition, these electronic tags can be used for user input via body gestures and also for video game applications where the viewer interacts with a video game via their body motions.

In another aspect, there is provided a system for an advanced remote control for fully functional interactive television. This remote control includes speech recognition, wireless mouse pointing, display of television programming and the interactive portal, and viewer identification, so that when a new viewer picks up the remote control, a new custom presentation of interactive content can be displayed. This remote control can also be used to watch the television programming, either in real time or delayed, and to interact with in real time or offline from the television program being watched. Thus, a viewer can rewind the television video displayed on the remote control while others in the room continue to watch the television program uninterrupted, and the viewer with the remote control can freeze the image and begin interacting with the television program independently of the other viewers in the room and the image on the main television screen. The remote control provides access to stored personal information on each viewer, such as credit card information, address and telephone numbers, work and recreational activity information and profiles, and so on. Further, this advanced remote control can access the viewers' profiles either internally or via a packet switched network so that if a particular person's remote control is taken to another home or business which has a similar system of the present invention, that viewer may pull up his or her profile and control the display of the television as well as access additional interactive content related to the programming being displayed on the television. The stored personal information can be stored either in a network server with local conditional access and authentication via encryption techniques such as triple-DES, or can be completely localized in the remote control. Importantly, the personal information stored can also include the viewer's personal schedule of activities, and the system can use this information to automatically schedule television viewings, whether the viewer is in his own home or another location.

In another aspect, there is provided a method whereby viewers can communicate two-way in real time with providers of television programming and interactive content, or with other viewers through the system in order to request additional information, technical support, to purchase items not recognized by the automatic recognition system, or to chat with other viewers during television programs. The system records and transmits the viewers' previous actions in order to facilitate the viewer's request in this application. For the chat application, viewers can select from a variety of display methods (including superposition of other viewers' voices onto the audio track) in order to have a real time chat session ongoing with the television programming. Viewers can choose to join particular groups where chat sessions follow particular formats or interests. An example of this application is for viewers to watch a television program that was originally intended to be serious, but the viewers join a parody chat group that constantly makes fun of events happening on the program, thereby transforming the program from a serious program to a humorous interactive experience.

In another aspect of the present invention, viewers can completely customize the presentation of television programming, including the combining of multiple channel content. This includes the combination of any selected video area from one channel onto another channel. For example, viewers may paste the news banner from the bottom of a news channel such as CNN or the stock ticker banner from CNBC onto any other channel they are watching. Similarly, the closed caption text from any other channel may be displayed on a banner or in a small window anywhere on the screen with an independent channel being viewed on the main screen. This channel combining concept applies to any information that is available from other television channels or from interactive television content providers being combined with another independent channel that is being viewed. For conventional analog video channels, the closed caption text will need to be demodulated in a server facility with access to all channels, and the closed caption and other interactive content sent to the customer premises equipment via switched packet network. When television channels are transmitted via quadrature amplitude modulation (QAM) carriers such that many channels are on a single carrier, the customer premises equipment can detect and process the closed caption and additional interactive content directly from the QAM carrier. In fact, the viewers are able to completely change the format and experience of the broadcast. For example, viewers can superimpose interactive content from other sources that converts a serious program into a comedy via inclusion of comedic commentary from other viewers or from an interactive source designed for that purpose. In this aspect, viewers may select from a variety of ‘experiences’ that they attach to the television program in order to personalize it.

In another aspect of the invention, a method is described whereby the television viewers may change the television viewing program experience from a linear, structured presentation of the program to a segmented, filtered, time-altered, enhanced version of the same program in order to match an activity of the viewers. An example would be a news program where after initially recording the entire program, the individual news segments are identified and isolated from the stored video so that when the viewer plays the stored program, the viewer can select only those segments of interest or add segments from other stored and segmented broadcast news programs in order to build a personalized news program which contains only those segments of greatest interest to the viewer, and in the order preferred by the viewer.

In another aspect of the invention, for programs that viewers store and watch over again several times, the system continuously updates the interactive content associated with the program to further enhance it and to update interactive content based on other viewers feedback or activities associated with the program. Each time the viewer plays the program, whether stored or rebroadcast, new interactive content and applications are available such that the program is transformed from a “one viewing only” experience, to a “watch over and over” or “evergreen” experience due to the new content.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE FIGURES

The present invention will be described with reference to the accompanying drawings. The drawing in which an element first appears is typically indicated by the leftmost digit(s) in the corresponding reference number.

FIG. 1 illustrates an overall network diagram for provision of fully interactive television content that is integrated with existing television broadcasts or stored programming. In this figure, elements of interactive television user interface are contained both in central repositories and also in the customer premises equipment.

FIG. 2 shows a system of the present invention for integration of interactive content with existing television material where the interactive content is received via a packet switched network and the television programming is received conventionally.

FIG. 3 shows a system of the present invention for a user interface that allows viewers to fully interact with the television programming.

FIG. 4 shows three example methods of the present invention for processing viewer speech commands and other viewer sound inputs.

FIG. 5 shows customer premises components in the system of the present invention for a fully interactive television system.

FIG. 6 shows a system of the present invention for an advanced remote control that uses wireless input/output from a packet switched network, a high quality computer display screen, pen based input, aural input/output, and conventional control buttons to allow viewers to view and interact with television programming independently of other viewers watching the main television screen in a particular room, and allowing them to take the television viewing and interaction experience into other rooms.

FIG. 7 shows other example remote control options for the system of the present invention.

FIG. 8 shows an example television or remote control screen of the present invention for a chat application which combines two-way, real time communications among viewers with a television program.

FIG. 9 shows an example of an alternate chat display method of the present invention.

FIG. 10 shows an example of the channel combining concept of the present invention.

FIG. 11 shows another example application of channel combining of the present invention where multiple home services are combined with weather alerts for a sleep channel.

FIG. 12 shows a system of the present invention for channel combining where multiple news sources from a variety of media types are combined into a single, customized news channel for individual viewers.

### DETAILED DESCRIPTION OF THE INVENTION

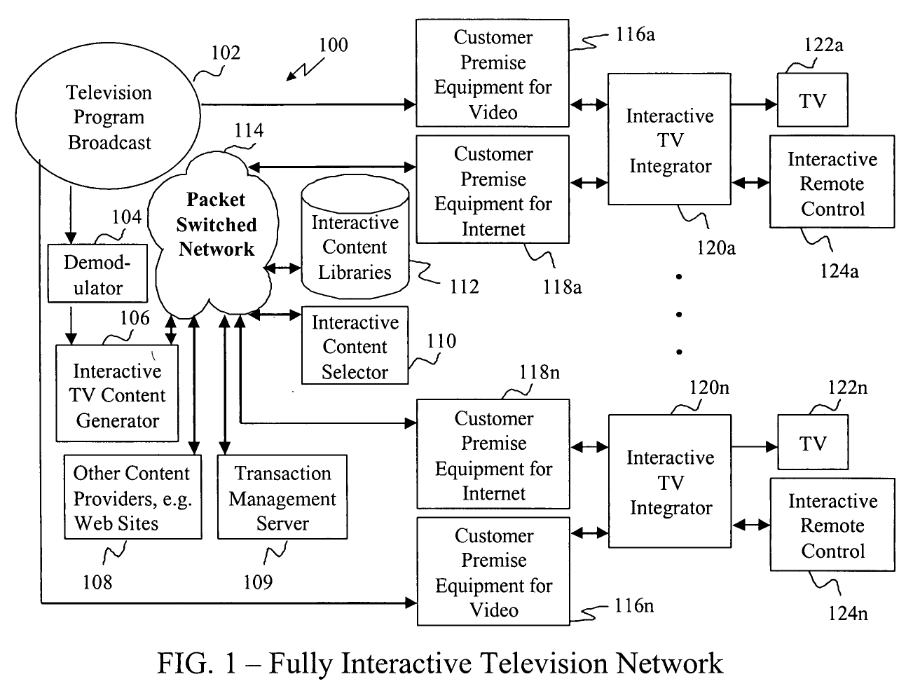

FIG. 1 shows a network 100 for provision of fully interactive television. Interactive content intended for integration with the television program and/or broadcast 102 is initially generated by the interactive TV content generator 106 and stored in the interactive content libraries 112. The interactive content generator 106 will be used prior to the broadcast or playing of a particular program to develop initial interactive content for storage in the libraries 112, and the generator 106 will also be used to generate content during the broadcast or playing of the television program. There are thus both off-line and real-time aspects to the interactive content generator. For real-time content generation, the television broadcast, which may be received via cable, satellite, off-air, or via packet switched network 114, will be demodulated by the demodulator 104 if received at radio frequency (RF), otherwise it will be received by the content generator 106 via the packet switched network 114.

The interactive content generator uses information contained in the television program, information previously stored in the interactive content libraries, and information from other content providers 108 to develop and synchronize candidate interactive television content to the television program. If the interactive content must be purchased by the viewer, and/or if the interactive content contains opportunities for purchases based on the content, then the transaction management server 109 coordinates the billing and purchases of viewers, and also provides other customer fulfillment functions such as providing coupons, special discounts and promotions to viewers. During actual broadcast or playing of the interactive television program, the interactive content selector 110 uses information from other content providers such as interactive television program sponsors, and viewer preferences, history, and group viewer preferences to select the specific interactive content which is to be associated with the television program. This interactive content can be customized for each viewer based on his or her preferences, selections during the program, or demographics. The interactive content chosen by the content selector is transmitted to the individual viewers via the packet switched network 114 and the customers' choices, preferences, and purchase particulars are also retained in the transaction management server and may be transmitted in part or in whole to interactive content providers 108 for the purpose of customer preference tracking, rewards, and customer fulfillment functions.

At the customer premises, the video reception equipment 116a receives the conventional television program, while the Internet equipment 118a receives the interactive content designed for the television program and customized for each individual viewer. The conventional video and interactive content are then integrated by the interactive TV integrator 120a for display on the customer's TV 122a and for interaction with the customer's interactive TV remote control 124. The interactive TV network simultaneously connects thusly to a plentitude of customer premises from one to n, as indicated by the customer premises equipment 116n through 124n. Thus, the interactive network shown in FIG. 1 simultaneously provides individualized interactive content to a plentitude of viewers that uses both previously developed interactive content as well as content developed during the program broadcast. The network therefore allows current television programming to be transformed into fully interactive and personalized interactive television via the devices shown in FIG. 1. The television program used for developing and delivering the interactive content may be completely devoid of any interactivity, or may include interactive content developed by other systems. This legacy interactive content will be preserved by the present invention and can be provided to the viewers if they desire.

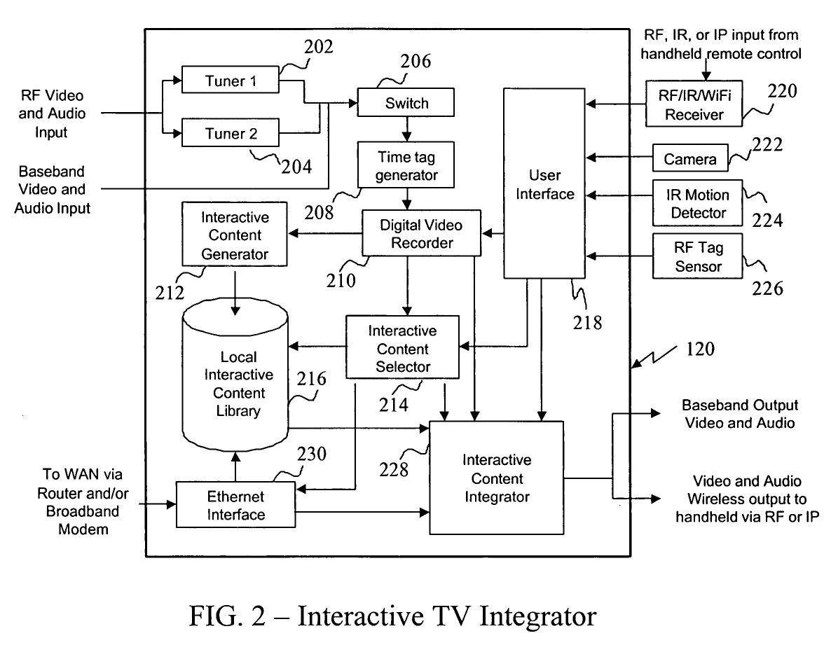

FIG. 2 shows an example interactive TV integrator that includes local versions of the interactive content generator 106, the interactive content libraries 112, and the interactive content ranking processor and selector 110. Since these versions are likely to be much smaller in scale and capability, they are renumbered as shown in the figure, but importantly, as the functions of the more capable centralized versions are migrated into the local versions, the interactive television network of the present invention has the capability to migrate from a centralized server architecture to a peer-to-peer network architecture where content can be stored primarily in customer premises, even though backups of the content will no doubt be archived centrally. Hence block 212 in the figure corresponds to block 106 previously, block 214 to block 110, and block 216 to block 112.

The RF video and audio are converted to baseband by the first tuner 202 and the second tuner 204 for passing to the switch 206. Alternately, the baseband video and audio may be input to the system directly and fed to the switch 206. Next time tags are generated from the video and audio by a time tag generator 208. The time tags are input along with the video and audio to a digital video recorder 210 for recording the television program along with time tags. The recorded digital video is provided to the interactive content generator 212, the content selector 214, and the interactive content integrator 222. The content generator works similarly to block 106 of FIG. 1, likewise the content selector is similar in function to block 110 of FIG. 1. The versions in the interactive TV integrator may have reduced functionality, however. And the interactive television content generated by 212 is sent to content libraries 216 which are similar to block 112 of FIG. 1 albeit reduced in scale, and the libraries are also fed by interactive television content received via packet switched network through the Ethernet interface 230. This Ethernet interface permits two-way, fully interactive applications to be delivered to the television viewer. For example, viewers may be offered an interactive application from an advertiser which when selected, activates a real time, two-way communications channel between the viewer (or multiple viewers) and the advertiser either directly, or via the transaction management server 109 for purposes of customer response and/or fulfillment. This real-time, two-way communications channel may be via conventional point and click, telephone conversation, videoconference, or any combination of the above. This two-way communications channel may also be implemented using conventional downstream and upstream communications channels on cable networks, for example, in which case the Ethernet interface 230 may not be necessary. Further, the real-time communications channel may be multipoint, as in a chat room, telephone conference call, or videoconference call.

The viewer controls the interactive television integrator via the electronic receiver 618, which may use RF, IR, WiFi, 220 or any combination thereof for signaling between the remote control and the interactive television integrator. Further, a camera 222, an infrared (IR) motion detector 224, and/or an RF tag sensor 226 may also be used to provide viewer input to the user interface 218. The interactive television integrator can then process viewer inputs and transmit them back to centrally located transaction management servers, interactive content selectors, and/or other content providers. This two way interactive communication channel can be used for viewer commands, voice or video telecommunications or conferencing, or for setting up viewer preferences and profiles. Note that these receivers and sensors may be external devices, or may be integrated within interactive television integrator.

The user interface block 218 controls the digital video recorder, the interactive content selector, and an interactive content integrator 228. The content integrator is where packet based interactive content generated locally or remotely and selected by the content selector is merged with the television programming and presented to the viewer either via baseband video and audio output, or via video and audio wireless IP streaming to a remote control, or both.

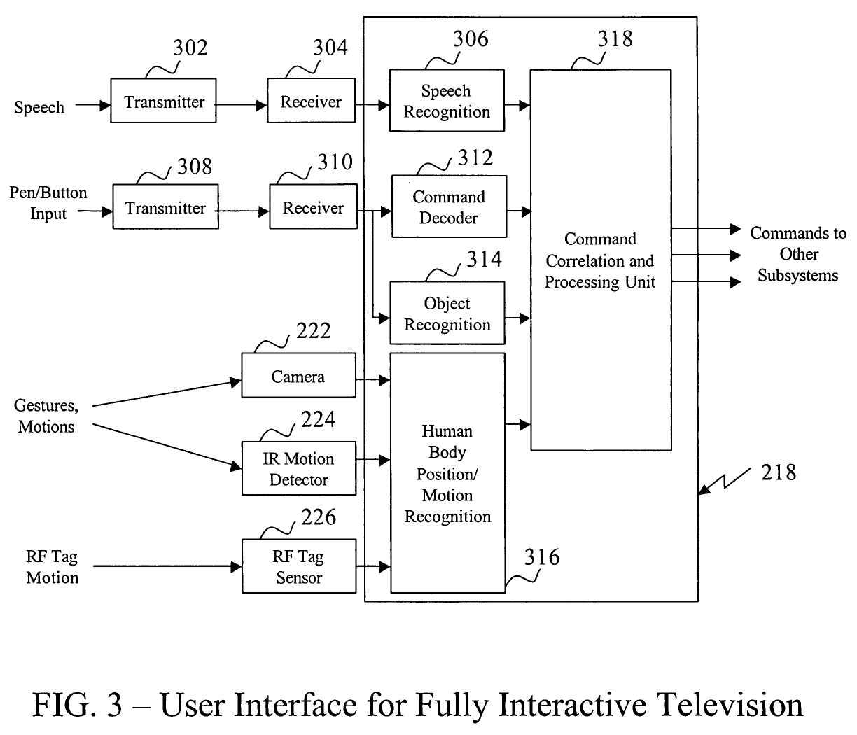

FIG. 3 shows an example user interface 220 designed to process a variety of viewer input data in order to provide a natural interface between the viewer and the interactive television content. The wireless speech transmitter 302 and receiver 304 are used to input viewer speech into the speech recognition processor 306. Unlike generic speech recognition systems, the interactive television speech recognition speech recognition processor benefits from the smaller vocabulary and grammar of speech commands, and further benefits from knowledge of typical commands and the smaller set of available commands based on the context of the interactive television content being displayed. Hence, the speech recognition processor 306 can be implemented much more efficiently than more generic speech recognition systems.

For remote controls with touch screen as well as conventional button inputs, these pen and button inputs will be transmitted 308 and received 310 for decoding 312 into commands and point and click type selections. For pen-based inputs, the input may result from a viewer using their pen to outline an object on the remote control screen for which the viewer wishes additional information. Hence, these viewer inputs are also processed by an object recognition processor 314. Similarly, the camera 222 and IR motion detector 224 capture gestures and other motions by the viewer for interacting with the interactive television content and send them to a human body position and motion recognition processor 316. Finally, if RF tags or other body sensors are present with an accompanying RF tag sensor 226, these inputs are also sent to the human body position and/or motion recognition processor 316.

The recognized speech, commands, image objects, and human body positions and/or motions are sent to a command correlation and processing unit 318, which correlates simultaneous or nearly simultaneous viewer inputs and actions in order to improve the accuracy of recognition and to identify groups of viewer inputs that lead to specific actions by the user interface. Corrected commands are then output by the command correlation and processing unit 318 to other subsystems in the interactive television content integrator.

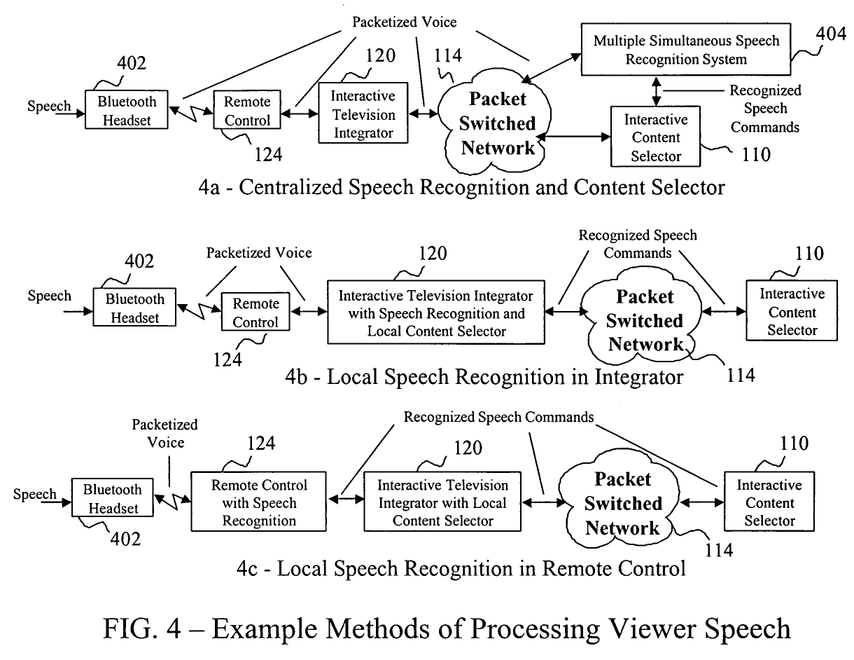

FIG. 4 depicts three example implementations of speech recognition processing in the system of the present invention. In FIG. 4a, speech is sampled in a headset such as a Bluetooth headset 402, and the sampled speech is then packetized and transmitted unrecognized to the remote control 124, and thence to the interactive television integrator 120, and then via packet switched network 114 to a centralized multiple simultaneous speech recognition system 404 which output the recognized speech to a centralized interactive content selector 110, which then transmits the selected interactive content via packet switched network 114 back to the interactive television integrator 120 for viewer selection via the remote control 124. The advantages of this implementation include the fact that often, many viewers will make similar speech commands at the same, or nearly the same time, which means that the multiple simultaneous speech recognition system 404 can take advantage of more clearly enunciated commands from one viewer to assist in accurately recognizing commands from a viewer who speaks less clearly. Essentially, the recognized commands with minimum estimated error are used to correlate with commands with higher estimated error to improve the speech recognition performance. Further, the centrally located version permits easy correlation of multiple viewers' inputs for the purpose of ranking interactive content in the content selector 110 that is selected for transmission to viewers.

FIG. 4b depicts a local speech recognition implementation wherein the speech recognition occurs in the local interactive television integrator. In this case, the recognized speech commands are used to select content in the local content selector 120 as well as from the centralized content selector 110. The advantages of this approach include the fact that the bandwidth requirements in the packet switched network are lower since encoded speech commands rather than sampled and packetized speech are transmitted, and further the fact that the local speech recognition benefits from training to a relatively small number of viewers. Similar to the centralized version previously described, when speech recognition is located in the content integrator 120, it is still possible to improve recognition performance via processing of multiple simultaneous, or nearly simultaneous viewer inputs, in this case however the viewers must all be in the same home.

FIG. 4c depicts a local speech recognition implementation wherein the speech recognition occurs in the remote control itself 124. In this case, the speech recognition is for a single user, so at the sampled speech waveform level, only a single viewers' speech must be used for recognition processing. In all implementations, however, the speech commands sent to the centralized content selector 110 may be corrected or enhanced based on multiple viewer inputs to the content selector.

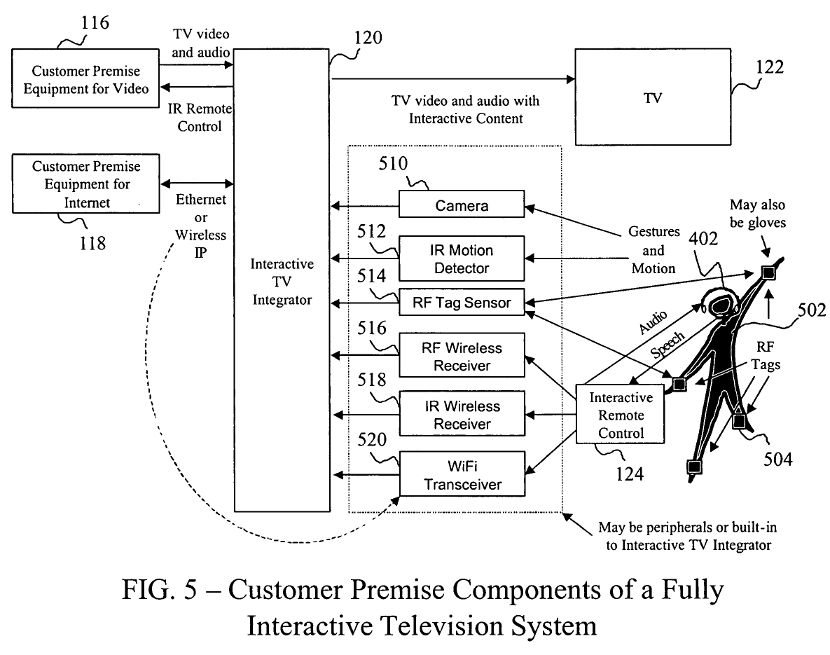

FIG. 5 shows the customer premises components of a fully interactive television system. In this particular embodiment, the camera 510, IR motion detector 512, RF tag sensor 514, RF wireless receiver 516, IR wireless receiver 518 and WiFI transceiver 520 are shown as devices external to the interactive TV integrator 120, however in other embodiments they may be integrated within the interactive TV integrator 120.

Video enters the customer premises via the customer premises equipment 116, which can be either a cable set top box, direct broadcast satellite set top box, DSL video set top box, or off air antenna for off air broadcast video. Packet data enters the customer premises via the customer premises equipment for Internet 118, which can be either a cable modem, DSL modem, direct satellite modem (either two way or one way with telephone return). Both video and packet data are input to the interactive TV integrator 120 for display of integrated television and interactive television content on the TV 122 and also on the interactive remote control 124. The viewer 502 is able to interact with the interactive television content via a variety of input methods such as gestures to a camera 510, motion to an IR motion detector 512, gestures and motion from RF tags 504 to an RF tag sensor 514, and speech and commands from the interactive remote control 124 which may be transmitted to the interactive TV integrator 120 via RF wireless 516, IR wireless 518, WiFi 520, or any combination of RF, IR and WiFi. Additionally, the viewer 502 may receive and input audio to the remote control 124 via a wired or wireless headset 402 for applications such as audio chat during television broadcasts. Note that viewer identification is also performed by the system of the present invention, either via voice identification from the sampled speech, or via data entry into the remote control, or via RF tags worn by the viewer during interactive TV viewing.

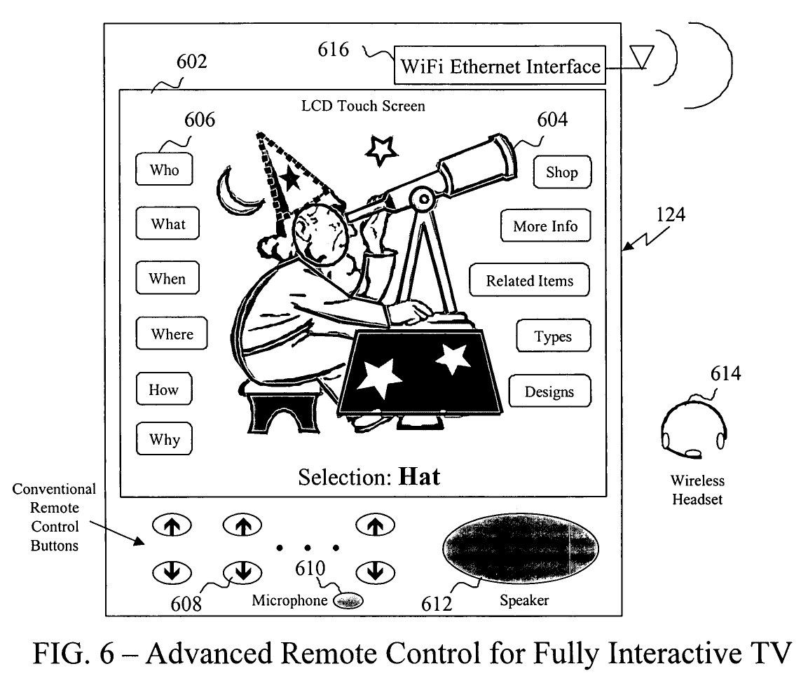

FIG. 6 shows an example embodiment of an advanced interactive television remote control 124 for fully interactive TV. The LCD touchscreen 602 can display live or recorded video received via the WiFi Ethernet interface 616. In this case, the video is sent as packetized digital video which can be either MPEG2, MPEG4, or any other digital video compression scheme. At any time during the television program, the user uses the microphone 610, the conventional remote control buttons 608, or the touchscreen with dynamic menu buttons 606 to pause the television program. At this point, superimposed on top of the frozen television image will be additional interactive TV buttons and options 606, as well as outlines of objects in the image 604. These outlines are either sent to the interactive TV integrator 120 via the packet switched network, or are generated in the interactive TV content generator 212 using MPEG4 compression or other edge and object detection techniques, or if sufficient processing power is resident, in the remote control itself. A single outlined object may be selected for further interactive options, or for typical options such as shopping, more info, related items, types, designs, and so on. For information gathering, a selected object may also be used in conjunction with questions such as who, what, when, where, how, why in order to easily navigate to more information on the selected object. For example, if the hat in the image is selected as shown, and the viewer selects the question “who,” the interactive television system would jump to information about individuals typically wearing such hats (astronomers or magicians, in the example shown), or to the specific individual shown in the image if his name were known. The viewer can augment the interactive navigation via the microphone 610 that leads to speech recognition of the viewer's commands.

An example of the combination of pen-based (or any other touchscreen, laser pointer, RF pointer, or any other screen pointing technology) and speech-based input may illuminate the benefits of the present invention: suppose the viewer desired information on the type of telescope in the image, and that initially, the system did not highlight it. With his pen-based input, he can draw a line outlining the telescope, after which a new button ‘recognize’ would be presented for selection. Suppose that upon initial recognition of the object, the system were unable to accurately identify the outline as a telescope. Upon notifying the viewer (object not recognized), the viewer could speak the name “telescope” which is recognized by the speech recognition system, and then the outlined image could be correlated with all types of telescopes so that a match of the exact type of telescope shown in the image is found. Finally, new buttons 606 are presented with options related to that type of telescope such as examples, design, purchase, inventor, and so on.

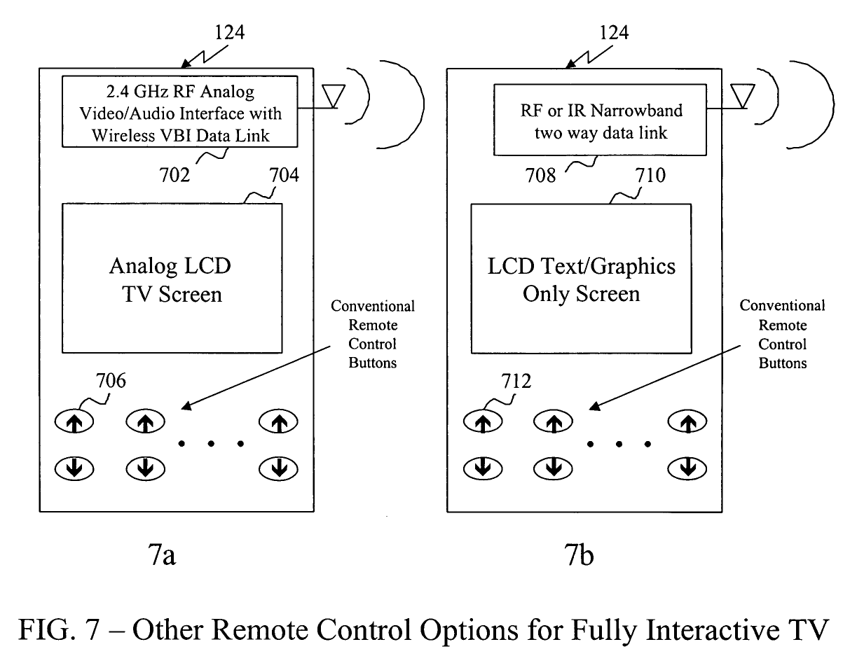

FIG. 7 shows two alternate embodiments of interactive TV remote controls that are less capable than the one shown in FIG. 6. In FIG. 7a, the video is sent to the remote control 124 as an analog signal via the 2.4 GHz video/audio interface 702 for display on a non touchscreen analog video LCD screen 704. For this embodiment, the annotations and buttons will have to correspond to the conventional remote control buttons 706, which may be below the screen, on the sides, above, or any combination thereof. In FIG. 7b, the interactive TV remote control is not able to display the actual video, but rather displays dynamically changing button labels for viewers to navigate and select interactive material within the interactive TV program using a text or text and graphics LCD screen 710. Further, the data link between the remote control and the interactive TV integrator 708 is likely an RF or IR narrowband data link, since video is not being sent.

In all implementations, the remote control or the interactive TV integrator itself provide the capability for stored viewer profiles to be called up by the viewer in order to customize the interactive experience as well as call up personal information required for making transactions using the system. The personal information such as credit card data, home shipping and billing address data, and other data related to the viewer's personal life such as schedule of activities, common goals and interests in television activities, common activities when watching television, and so on, will be stored either on a networked server so that it can be accessible by the viewer when using the system at a location other than the primary location, or can be completely contained in the viewer's interactive TV integrator and/or his remote control. The remote control can also include a smart card type of interface so that viewers' personal data or conditional access data are transportable to other devices such as other remote controls or interactive TV integrator implementations. The method by which a viewer may access his or her personal profile and personal data may include, but are not limited to triple DES, public key encryption, digital signatures, voice recognition and identification, fingerprint identification, and other biometric technologies. By making the viewer interface to the system completely personalized to each viewer, it is possible for the viewer to select television programming for viewing in a very different manner from the current approach of selecting a program from an electronic program guide based on time, type, or category of show. In the system of the present invention, the system keeps track of commonly watched programs and program types and genres and can also correlate them with the time of day or day of week that the viewer typically watches the programs. Hence, the system of the present invention provides an increased performance in predicting viewer preferences and selections so that when the viewer logs on, the most likely selections for that viewer are presented. This applies to both the television program itself, as well as to the interactive content associated with the television program.

In the system of this invention, in addition to the normal web-browser type navigation to select interactive content, the present invention allows the television program itself to become a navigation control for selection of interactive content. By pausing, rewinding or fast-forwarding the television program, different interactive content may be accessed since the interactive content is based on the portion of the television program being viewed as well as viewer preferences and the goals of content providers and product vendors.

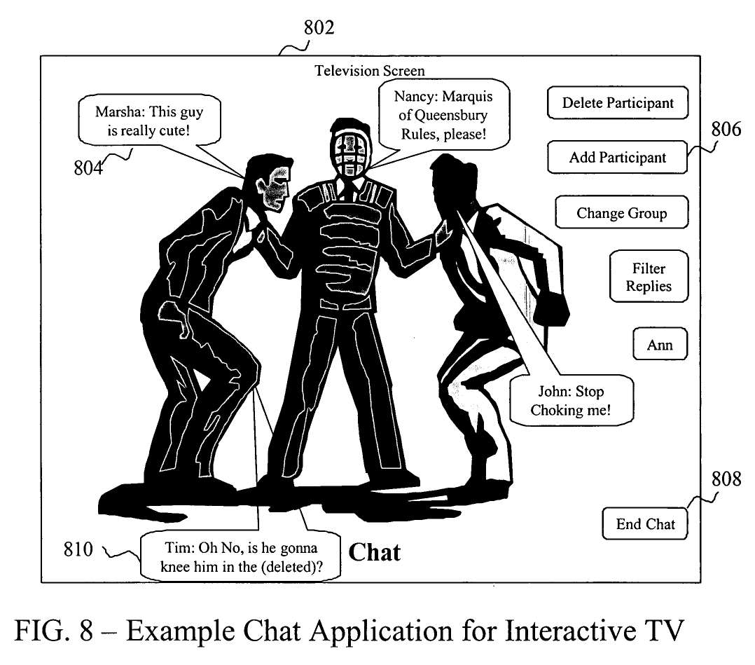

FIG. 8. depicts an example chat application for interactive TV using the system of the present invention. The idea is that multiple viewers in different homes are watching the same television program simultaneously, and are chatting with each other while the program is ongoing. The technology for implementing the chat can be simple text messaging, instant messaging protocols, or voice over IP. In this embodiment, if viewers are using a remote control with speech capture and recognition, viewers can input their comments into the remote control, and tap the image on their remote touchscreen where they want the comment to be displayed for other viewers 804. The sum of all recent comments are then shown on the television screen 802. Alternately, viewers may use their headsets with microphones so that the chat session is essentially a group conference call where all viewers participating in the chat hear the voices of other chatters in real time as the program is progressing. A benefit of the speech recognition version is that curse words from chatters can be automatically deleted 810 if detected so that participants are not presented with material they prefer not to view. The interactive TV system displays dynamically changing buttons/selections 806 which can change based on the content in the program or on the preferences of the viewer. At any point, the viewer may end their participation in the chat session via the end chat selection 808.

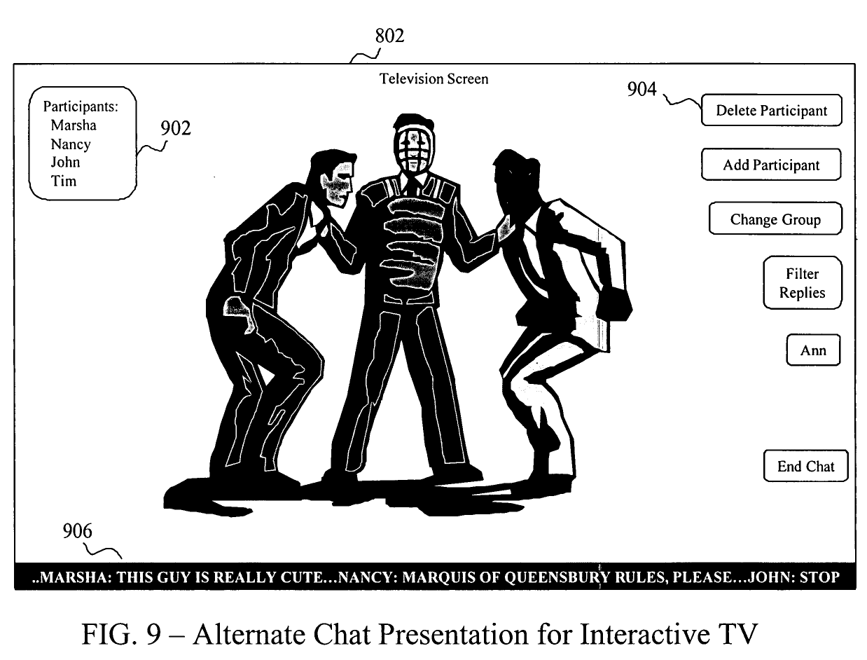

FIG. 9 depicts a slightly different embodiment of the chat session whereby viewers comments are displayed on a banner bar 906 at the bottom of the TV screen 802. A list of participants can also be displayed 902, as well as buttons for changing the chat display or exiting the chat 904.

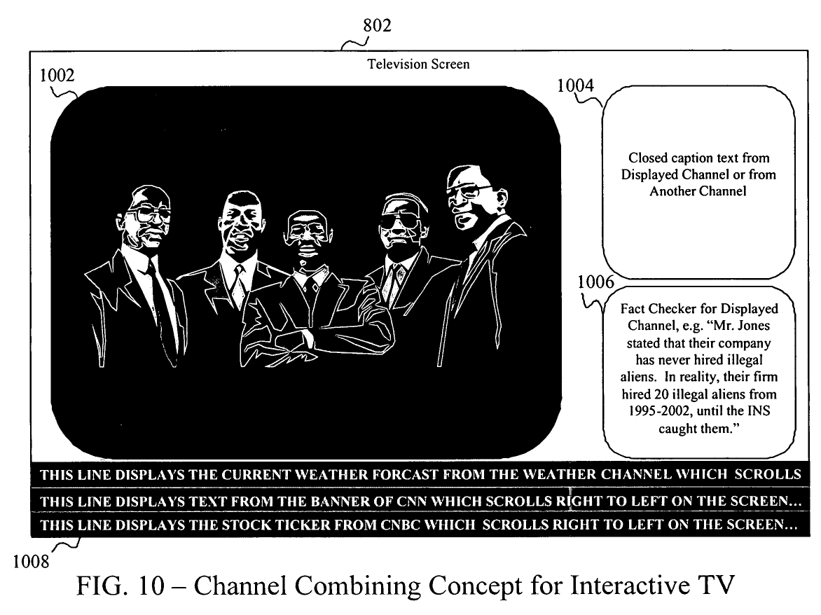

FIG. 10 depicts the channel combining concept for interactive TV, where information gathered from multiple TV channels is displayed on a single screen 802 in order to customize the experience for each viewer. In this case, a news program is being watched in traditional manner in a reduced size window 1002 from a conventional television channel, while simultaneously the closed caption text from another news channel on the same topic is displayed in a smaller window 1004, and also text from an Internet text channel which in this case is a live fact checker service where statements being made in the conventional channel 1002 are being analyzed in real time by a team of researchers and whenever facts are misstated or distorted, the fact checker team sends text to that effect to the fact checker channel 1006. Further, while these channels are ongoing, there are three banner text lines 1008 scrolling across the bottom of the screen which give the local weather forecast from a weather channel, the banner news text from a news channel such as CNN, and the stock ticker banner from a financial channel such as CNBC. As may be evident, any number of banner text lines can be displayed from any source, either television channel, Internet channel, or recognized text from an audio broadcast channel (or via Internet) may be displayed thusly or using alternate display techniques such as emplacement in windows or sending audio to headsets worn by viewers, and still be within the realm of the present invention. It should be noted that using these techniques, it is possible for viewers to customize the presentation of a television channel such that the experience is completely changed from say a serious news show, to a parody of the approach used by the particular news channel. Further, since the text of audio within each sub channel displayed is being recognized, filtering can take place wherein viewers can set the system to automatically change to a different source when content they wish to avoid is present. Using the digital video recording capability of the system and the fact that multiple tuners are present, the system can record news from two separate news channels and permit the viewer to switch between the channels automatically in order to avoid news on a particular topic, for example, or of a particular type, such as violent crime news, or follow a particular topic of interest.

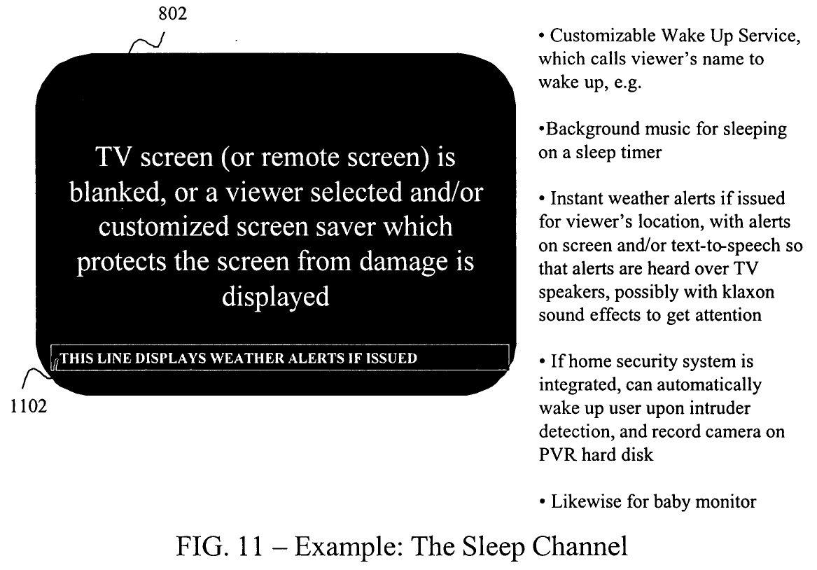

FIG. 11 depicts another customized channel for viewers in the interactive television system of the present invention. In this case, the viewer has chosen to set the system for a sleep channel, where the TV screen 802 is either blanked or a viewer selected and/or customized screen saver is displayed. The audio track contains a viewer selected background music source, and the system engages a sleep timer to automatically turn off the music after a specified time, all viewer selectable. Since the system is connected to a viewers packet switched network in the home, the system can also integrated information from other home devices such as networked home security systems or networked baby monitor systems such that if an alarm condition is detected, the television display instantly switches to the video source of the alarm and a loud alarm signal is sent to the television audio speaker. Likewise, the system monitors weather alerts from a weather channel, and if warnings are issued for the viewers area, the system also wakes up the viewer via alerts 1102 and loud audio. Finally, if no alarm conditions are detected throughout the night, the system performs a wake up service for the viewer which is completely customizable. For example, the system automatically goes to a particular channel of interest at time of wake up, or displays the viewers planning information for the day, or plays a stored exercise routine, and so on. Since the system also provides for speech recognition and text-to-speech, the system can actually call the viewer's name to wake them up, much like a wake-up service in a hotel.

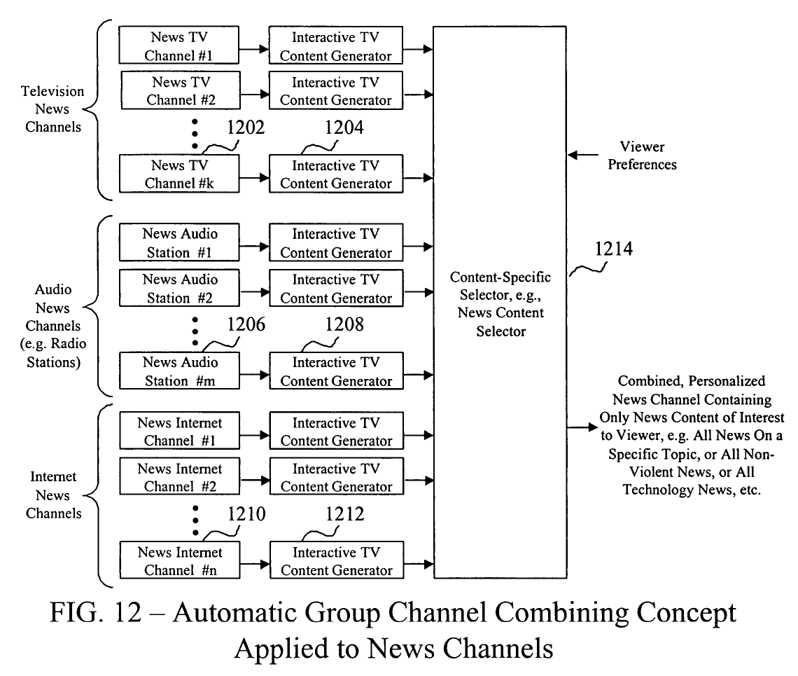

FIG. 12 depicts the automatic group channel combining concept of the present invention whereby multiple sources from a variety of media types are searched by the system and the results combined in order to customize and personalize the television experience for the viewer. In this example, news from a multitude of television news channels 1202 is processed by a news channel-specific content generator 1204 in 30 order to generate interactive news content from those sources for selection by a news specific content selector 1214. Similarly, news from audio channel sources 1206 such as off-air radio stations is processed by an audio specific interactive TV content generator 1208 for delivery to the content selector 1214, and also news from Internet channels 1210 are likewise processed 1212 and sent to the content selector 1214. The content selector then provide a plethora of news segments to the viewer which have been filtered according to the viewer's goals, such as ‘all news about Iraq’ or ‘no news with violence in it’ or ‘all news about technology’.

In order to present different aspects of the invention, several example applications are given below using a particular type of television program as a vehicle for describing the interactive technology of the invention. The examples include, but are not limited to: a reality TV program; a cooking program; and a viewer skipping commercials using digital video recording technology.

Consider first a cooking program. With the present invention, viewers may pause the programming at any instant and perform any of the following activities. First, one can pull up a recipe of the current item being cooked on the show and save the recipe or send it to a printer, or have it printed by a centralized server and subsequently mailed to the viewer. Second, one can save the recipe in video form such that when it is replayed, the appropriate times between steps are added in accordance with the actual recipe, including the insertion of timers and other reminders, hints, and suggestions for someone actually cooking the recipe in real time. When breaks between cooking steps occur (in order to wait for a turkey to bake, e.g.), the viewer is presented with opportunities to purchase cooking tools, order supplies for recipes, watch clips of general cooking techniques, and so on. Note that for cooking entire meals, the viewer will likely be switching between different dishes, and the system will need to adjust the timing of inserted breaks in order to stage the entire meal preparation. When the program is initially saved, the recipes are downloaded from the web and an automatic shopping list for the needed items is generated, potentially using the RF tag technology embedded in next generation product labels to identify products on hand versus those in need of purchasing, with a coupon for purchasing those items at a local grocery store, which also receives the grocery list as soon as the viewer approves the order for the supplies. Third, rather than be oriented towards a particular show or recipe, the interface can be imagined as a ‘dinner channel’ where at dinner time, the viewer goes to that channel, and selects several recipes, checks the availability of supplies, modifies the recipes, and then when ready, plays the video which is composed of downloaded or saved cooking show segments on each recipe that have been staged and had pauses and timers appropriately inserted in order to match the preparation of the meal in real time. If the viewer had saved the various cooking show segments previously, the combined dinner channel clips can be set to play automatically so that the meal is ready at a prescribed time. Fourth, the recipe and the cooking show segment can be modified or customized by the viewer according to dietary constraints, available supplies, and so on.

Consider next a reality TV program such as Survivor. Viewers may transform the program using the system of the present invention into the following types of programming: 1) add humorous commentary from other viewers, previous viewers, or live humor commentators to convert it into a comedy; 2) add educational and/or cultural information addenda throughout the program to convert it into an educational experience; 3) add video and/or trivia game opportunities throughout the program to convert it into a gaming experience; 4) Add exercise routines correlated with the challenge activities in the program to convert the program into a workout video experience; 5) add cooking recipes and augment the program with cooking videos to transform it into a cooking program; and 6) convert the rating of the program from say PG-13 into G rated via automatic deletion of portions with higher-rated content. In effect, viewers may initially select the nature of, or activity associated with a television program they wish to experience differently, and the system converts the television program to the desired experience for them via the interactive content selections made by the system and the viewer.

Consider next the example of a viewer who skips commercials using the PVR functionality in the system. As the viewer continues to skip commercials, the system can accumulate data on the types of commercials skipped, and the types watched without skipping so that subsequent commercial breaks may substitute increasingly relevant commercials to that particular viewer. The system accomplishes this via switching from the broadcast TV program to IP video using the switched packet network in the content integrator when a sufficient number of commercials in the broadcast program have been skipped.

Consider finally a simple example of the dynamic nature of the user interface described herein. As a viewer watches a television program, keywords from the program episide are processed and correlated with keywords associated with the viewer's stored personal profile and whenever the viewer wishes to see additional interactive content related to the TV program as well as their personal interests, the viewer need only pause the TV program, whereupon he is presented with a screen full of selectable buttons that each point to a web page that provides information related to the viewer's profile keywords and the TV episode and/or series keywords. Selection of any particular button takes the viewer to that web page (which can also be stored content in the settop box), and in so doing, the keywords for that button are promoted in rank so that the next time the viewer pauses the TV program, the most recently selected keywords are presented first as options for additional information. In this manner, the system dynamically personalizes the interactive television experience based solely on the viewer's choices for interactive information related to the TV program. The system also processes these viewer selections to determine the ranking of advertisement information that is to be presented to the viewer, thereby targeting the viewer's personal interests for the recent past and present.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. A method for interacting with current analog or digital television programming comprising:
a natural viewer interface to command the system;
a natural viewer interface to view interactive content of the system;
an advanced remote control system that extends the natural interface of the system to the viewer remotely in a manner which is either dependent or independent of the television programming being viewed on the main television screen;
an embedded two-way communication capability that allows viewers to communicate with other viewers and/or content providers and/or product vendors during interactive television viewing;
a method of customizing the interactive television display such that content from sources other than the television programming being viewed can be combined with the television programming;
a method of altering the television programming being viewed so that segments may be rearranged, deleted, enhanced, or replaced;
a method of dynamically augmenting the television program such that subsequent viewings contain new content based on viewer feedback and/or content provider additions.

2. The method of claim 1, wherein the natural interface to command the system includes speech recognition of the viewer's spoken commands and recognition of the viewer's non-speech audio, and a portion of the recognition processing is located in a centralized server that all viewers can access, and a portion is located in an interactive TV integrator located in the customer premises.

3. The method of claim 1, wherein the natural interface to command the system includes speech recognition of the viewer's spoken commands and recognition of the viewer's non-speech audio, and a portion of the recognition processing is located in a centralized server that all viewers can access, and a portion is located in an interactive TV integrator located in the customer premises, and a further portion is located in an advanced remote control located in the customer premises.

4. The method of claim 1, wherein said natural interface to command the system includes image recognition of the viewer's hand and body gestures via a combination of a video camera and infrared (IR) motion detector.

5. The method of claim 1, wherein said natural interface to command the system includes image recognition of the viewer's hand and body gestures via radio frequency (RF) identification tags or sensors.

6. The method of claim 1, wherein said natural interface to command the system includes image recognition of the viewer's hand and body gestures via a combination of video camera, IR motion detector, and radio frequency (RF) identification tags or sensors.

7. The method of claim 1, wherein said natural interface to command the system includes processing a combination of speech recognition, recognition of non speech audio information, image recognition of the viewer's hand and body gestures via a combination of video camera, IR motion detector, and radio frequency (RF) identification tags or sensors.

8. The method of claim 1, wherein said natural viewer interface to view interactive content of the system includes automatic display of personalized interactive content or options for interactive content whenever the system is paused or played in interactive mode.

9. The method of claim 1, wherein said natural viewer interface to view interactive content of the system includes automatic pausing of the system when events such as viewers standing up and leaving the room are detected.

10. The method of claim 1, wherein said natural viewer interface to view interactive content of the system includes integration of the interactive content selections within the television program video, for example by outlining objects in the video image that provide launch points for interactive applications, and the outlines of objects are created partially in a central server and sent to the interactive TV integrator via a packet switched network, and partially in an interactive TV integrator located in the customer premises.

11. The method of claim 1, wherein said natural viewer interface to view interactive content of the system includes the use of the television program as a navigator for interactive content.

12. The method of claim 1, wherein said natural viewer interface to view interactive content of the system includes the ability to continue playing the television program unaltered on the main television screen while a paused or time-shifted version of the program is displayed with interactive selections on an advanced remote control device.

13. The method of claim 1, wherein said natural viewer interface to view interactive content of the system includes the ability to view the television program in either real time or time-shifted on the remote control using a wireless communication system between the interactive TV integrator and the remote control.

14. The method of claim 1, wherein said natural viewer interface to view interactive content of the system includes the ability of the viewer to select a personalized interface when using the system of the present invention in his or her premises or in another premises with the system of the present invention.

15. The method of claim 1, wherein said viewer interface of the system includes the ability to embed two-way communications into the interactive experience between viewers and other viewers, content providers, advertisers, or product vendors using a combination of voice over IP technology, text chat technology and instant messaging protocols.

16. The method of claim 1, wherein said viewer interface of the system includes the ability to customize the interactive television display such that content from multiple TV channels and interactive content received via separate communications channel can be simultaneously displayed.

17. The method of claim 1, wherein said viewer interface of the system includes the ability to customize the interactive television display such that content from TV channels can be stored and subsequently replayed with some segments shifted in time, altered, augmented, or replaced according to the viewer's commands, and/or the goals of content providers and/or advertisers and/or product vendors.

18. The method of claim 1, wherein said natural interface to command the system includes processing a combination of speech recognition, recognition of non speech audio information, image recognition of the viewer's hand and body gestures via a combination of video camera, IR motion detector, and radio frequency (RF) identification tags or sensors and further wherein said natural viewer interface to view interactive content of the system includes integration of the interactive content selections within the television program video, for example by outlining objects in the video image that provide launch points for interactive applications and the outlines of objects are created via a combination of data sent to the interactive TV integrator via packet switched network and data created locally by the interactive TV integrator.

19. The method of claim 1, wherein said natural interface to command the system includes processing a combination of speech recognition, recognition of non speech audio information, image recognition of the viewer's hand and body gestures via a combination of video camera, IR motion detector, and radio frequency (RF) identification tags or sensors and further wherein said natural viewer interface to view interactive content of the system includes integration of the interactive content selections within the television program video, for example by outlining objects in the video image that provide launch points for interactive applications and the outlines of objects are created via a combination of data sent to the interactive TV integrator via packet switched network and data created locally by the interactive TV integrator and further uses the television program as a navigator for the interactive content.

20. The method of claim 1, wherein said natural interface to command the system includes processing a combination of speech recognition, recognition of non speech audio information, image recognition of the viewer's hand and body gestures via a combination of video camera, IR motion detector, and radio frequency (RF) identification tags or sensors and further wherein said natural viewer interface to view interactive content of the system includes integration of the interactive content selections within the television program video, for example by outlining objects in the video image that provide launch points for interactive applications and the outlines of objects are created via a combination of data sent to the interactive TV integrator via packet switched network and data created locally by the interactive TV integrator and further uses the television program as a navigator for the interactive content, and further permits the television program to be paused either on the main screen only, the remote control only, or both when going into interactive mode.

21. The method of claim 1, wherein said natural interface to command the system includes processing a combination of speech recognition, recognition of non speech audio information, image recognition of the viewer's hand and body gestures via a combination of video camera, IR motion detector, and radio frequency (RF) identification tags or sensors and further wherein said natural viewer interface to view interactive content of the system includes integration of the interactive content selections within the television program video, for example by outlining objects in the video image that provide launch points for interactive applications and the outlines of objects are created via a combination of data sent to the interactive TV integrator via packet switched network and data created locally by the interactive TV integrator and further uses the television program as a navigator for the interactive content, and further permits the television program to be paused either on the main screen only, the remote control only, or both when going into interactive mode, and the television program can be played in real time or delayed on either screen independently of the other.

22. The method of claim 1, wherein said natural interface to command the system includes processing a combination of speech recognition, recognition of non speech audio information, image recognition of the viewer's hand and body gestures via a combination of video camera, IR motion detector, and radio frequency (RF) identification tags or sensors and further wherein said natural viewer interface to view interactive content of the system includes integration of the interactive content selections within the television program video, for example by outlining objects in the video image that provide launch points for interactive applications and the outlines of objects are created via a combination of data sent to the interactive TV integrator via packet switched network and data created locally by the interactive TV integrator and further uses the television program as a navigator for the interactive content, and further permits the television program to be paused either on the main screen only, the remote control only, or both when going into interactive mode, and the television program can be played in real time or delayed on either screen independently of the other, and further the television program itself is used to navigate through the interactive content and a two-way, real time or non-real time communication system between viewers, content providers, and/or product vendors is embedded within the system for use during viewing of television programming, using either voice over IP or chat technology such as text messaging or instant messaging, or any combination thereof.

23. The method of claim 1, wherein said natural interface to command the system includes processing a combination of speech recognition, recognition of non speech audio information, image recognition of the viewer's hand and body gestures via a combination of video camera, IR motion detector, and radio frequency (RF) identification tags or sensors and further wherein said natural viewer interface to view interactive content of the system includes integration of the interactive content selections within the television program video, for example by outlining objects in the video image that provide launch points for interactive applications and the outlines of objects are created via a combination of data sent to the interactive TV integrator via packet switched network and data created locally by the interactive TV integrator and further uses the television program as a navigator for the interactive content, and further permits the television program to be paused either on the main screen only, the remote control only, or both when going into interactive mode, and the television program can be played in real time or delayed on either screen independently of the other, and further the television program itself is used to navigate through the interactive content and a two-way, real time or non-real time communication system between viewers, content providers, and/or product vendors is embedded within the system for use during viewing of television programming, using either voice over IP or chat technology, or any combination thereof, and further permits the viewer to customize the interactive television display such that content from multiple television channels can be combined and simultaneously displayed.

24. The method of claim 1, wherein said natural interface to command the system includes processing a combination of speech recognition, recognition of non speech audio information, image recognition of the viewer's hand and body gestures via a combination of video camera, IR motion detector, and radio frequency (RF) identification tags or sensors and further wherein said natural viewer interface to view interactive content of the system includes integration of the interactive content selections within the television program video, for example by outlining objects in the video image that provide launch points for interactive applications and the outlines of objects are created via a combination of data sent to the interactive TV integrator via packet switched network and data created locally by the interactive TV integrator and further uses the television program as a navigator for the interactive content, and further permits the television program to be paused either on the main screen only, the remote control only, or both when going into interactive mode, and the television program can be played in real time or delayed on either screen independently of the other, and further the television program itself is used to navigate through the interactive content and a two-way, real time or non-real time communication system between viewers, content providers, and/or product vendors is embedded within the system for use during viewing of television programming, using either voice over IP or chat technology, or any combination thereof, and further permits the viewer to customize the interactive television display such that content from multiple television channels can be combined with interactive content received via separate communications channel and simultaneously displayed, and further that the television programming can be stored and segmented and subsequent playing of the programming can be done so with some segments shifted in time, altered, or replaced according to the viewer's commands and the goals of content providers and product vendors.

25. The method of claim 1, wherein said natural interface to command the system includes processing a combination of speech recognition, recognition of non speech audio information, image recognition of the viewer's hand and body gestures via a combination of video camera, IR motion detector, and radio frequency (RF) identification tags or sensors and further wherein said natural viewer interface to view interactive content of the system includes integration of the interactive content selections within the television program video, for example by outlining objects in the video image that provide launch points for interactive applications and the outlines of objects are created via a combination of data sent to the interactive TV integrator via packet switched network and data created locally by the interactive TV integrator and further uses the television program as a navigator for the interactive content, and further permits the television program to be paused either on the main screen only, the remote control only, or both when going into interactive mode, and the television program can be played in real time or delayed on either screen independently of the other, and further the television program itself is used to navigate through the interactive content and a two-way, real time or non-real time communication system between viewers, content providers, and/or product vendors is embedded within the system for use during viewing of television programming, using either voice over IP or chat technology, or any combination thereof, and further permits the viewer to customize the interactive television display such that content from multiple television channels can be combined with interactive content received via separate communications channel and simultaneously displayed, and further that the television programming can be stored and segmented and subsequent playing of the programming can be done so with some segments shifted in time, altered, or replaced according to the viewer's commands and the goals of content providers and product vendors, and further that new interactive content augments the television program based on viewers' feedback, viewer's commands, and the goals of content providers and product vendors.
